(19) United States
(12) Patent Application Publication
(10) Pub. No.: US 2026/0109353 A1
(43) Pub. Date: Apr. 23, 2026

(54) VEHICLE CONTROL DEVICE AND PROGRAM

(71) Applicants: DENSO CORPORATION, Kariya-city (JP); TOYOTA JIDOSHA KABUSHIKI KAISHA, Toyota-shi (JP); J-QuAD DYNAMICS Inc., Tokyo (JP)

(72) Inventors: Yuki TAKEUCHI, Tokyo (JP); Takahiro NARITA, Tokyo (JP); Yuji IKEDO, Sunto-gun (JP); Toshinori OKITA, Gotenba-shi (JP); Yoshinari TODA, Seto-shi (JP)

(21) Appl. No.: 19/359,223

(22) Filed: Oct. 15, 2025

(30) Foreign Application Priority Data
Oct. 17, 2024 (JP) 2024-182224

(51) Int. Cl. B60W 30/14; B60W 30/09; B60W 30/095; B60W 30/165; B60W 50/00

(52) U.S. Cl. CPC B60W 30/146; B60W 30/09; B60W 30/0956; B60W 30/165; B60W 50/00; B60W 2050/0083; B60W 2520/10; B60W 2520/14; B60W 2540/18; B60W 2552/30; B60W 2552/53; B60W 2556/10; B60W 2556/40; B60W 2556/50

(57) ABSTRACT

An ECU includes a turning amount estimation section that estimates a vehicle turning amount indicating the turning state of the vehicle as an estimated turning amount based on map information, an actual turning amount acquisition section that acquires a vehicle turning amount indicating an actual turning state of the vehicle as an actual turning amount, a deceleration-control section that cancels deceleration-control when the degree of deviation between the estimated turning amount and the actual turning amount is equal to or greater than a predetermined value, and a situation determination section that determines whether the deviation between the estimated turning amount and the actual turning amount is caused by a factor other than the map information. When it is determined that the deviation between the estimated turning amount and the actual turning amount is caused by factors other than map information, the deceleration-control section makes it less likely to cancel deceleration-control than when such a determination is not made.

### CROSS-REFERENCE TO RELATED APPLICATION

This application is based on and claims the benefit of priority from earlier Japanese Patent Application No. 2024-182224 filed on Oct. 17, 2024, the descriptions of which is incorporated herein by reference.

### TECHNICAL FIELD

The present disclosure relates to a vehicle control device and program capable of controlling a driving speed of a vehicle.

### BACKGROUND

Conventionally, a technology is known for slowing down a vehicle when it drives on a curved road using map information. For example, the technology described in JP 5468549 B evaluates the reliability of curve information based on map information from a navigation device and suppresses unnecessary speed control from being performed within curves based on unreliable curve information. Specifically, the technology includes an actual turning state variable acquisition means for acquiring actual turning state variables (e.g., yaw rate) that represent the actual turning state of the vehicle, and an execution feasibility determination means for determining whether deceleration-control should be performed based on the actual turning state variables, i.e., whether it is in an effective state or an ineffective state. Then, the deceleration-control is performed when the determination result of the execution feasibility determination means is in an effective state, and the deceleration-control is not performed when the determination result of the execution feasibility determination means is in an ineffective state.

### SUMMARY

A vehicle control device according to the present disclosure uses map information to perform deceleration-control for decelerating a vehicle when the vehicle is driving on a curved road, the vehicle control device includes a turning amount estimation section that estimates, based on the map information, a vehicle turning amount indicating a turning state of the vehicle when driving on the curved road, as an estimated turning amount, an actual turning amount acquisition section that acquires, as an actual turning amount, the vehicle turning amount that indicates an actual turning state of the vehicle when driving on the curved road, a deceleration-control section that cancels the deceleration-control when a degree of deviation between the estimated turning amount and the actual turning amount is equal to or greater than a predetermined value, and a situation determination section that determines whether the deviation between the estimated turning amount and the actual turning amount is caused by a factor other than the map information, wherein when the situation determination section determines that the deviation between the estimated turning amount and the actual turning amount is caused by a factor other than the map information, the deceleration-control is made less likely to be canceled than when such a determination is not made.

### BRIEF DESCRIPTION OF THE DRAWINGS

The above features of the present disclosure will be made clearer by the following detailed description, given referring to the appended drawings. In the accompanying drawings:

FIG. 1 shows a schematic diagram of a vehicle driving support system;

FIG. 2 shows a diagram of a driving scene in which an own vehicle is driving in out-in-out driving;

FIG. 3 shows a diagram of a driving scene in which the own vehicle is avoiding an obstacle;

FIG. 4 shows a driving scene in which the own vehicle is driving on an outside of a lane together with a preceding vehicle;

FIG. 5 shows a diagram of a driving scene in which understeer occurs due to excessive speed of the own vehicle;

FIG. 6 shows a flowchart of a procedure for deceleration-control when driving on a curved road;

FIG. 7 shows a flowchart of a situation determination process for determining a situation in which a deviation in a turning amount occurs due to factors other than map information;

FIG. 8 shows a flowchart of a process for variably setting a threshold value in another example;

FIG. 9 shows a diagram of a scene where the preceding vehicle is driving off the road;

FIG. 10 shows a flowchart of a process for canceling the deceleration-control in another example; and

FIG. 11 shows a flowchart of a process for canceling deceleration-control in yet another example.

### DETAILED DESCRIPTION OF THE PREFERRED EMBODIMENTS

In vehicles, driving may intentionally be performed on a driving line with a curvature different from that of a curved road. For example, when driving on a curved road, if the driver performs out-in-out driving, a curvature radius of the vehicle during turning will be greater than a curvature radius of the curved road. In this case, existing technology may consider the map information to be incorrect and cancel the deceleration-control unnecessarily. Therefore, there is room for improvement in existing technologies.

The present disclosure has been made in light of the problems set forth above and has as its object to provide a vehicle control device and program capable of appropriately control the deceleration of the vehicle when driving around a curve.

A vehicle control device according to the present disclosure uses map information to perform deceleration-control for decelerating a vehicle when the vehicle is driving on a curved road, the vehicle control device includes a turning amount estimation section that estimates, based on the map information, a vehicle turning amount indicating a turning state of the vehicle when driving on the curved road, as an estimated turning amount, an actual turning amount acquisition section that acquires, as an actual turning amount, the vehicle turning amount that indicates an actual turning state of the vehicle when driving on the curved road, a deceleration-control section that cancels the deceleration-control when a degree of deviation between the estimated turning amount and the actual turning amount is equal to or greater than a predetermined value, and a situation determination section that determines whether the deviation between the estimated turning amount and the actual turning amount is caused by a factor other than the map information, wherein when the situation determination section determines that the deviation between the estimated turning amount and the actual turning amount is caused by a factor other than the map information, the deceleration-control is made less likely to be canceled than when such a determination is not made.

When a vehicle is driving on a curved road, deceleration-control is performed using map information to slow down the vehicle. In addition, if the map information is incorrect, proper deceleration-control cannot be performed. Therefore, when driving on the curved road, the estimated turning amount estimated based on the map information and the actual turning amount indicating the actual turning state of the vehicle are acquired as the turning amount of the vehicle indicating the turning state of the vehicle. Then, when the degree of deviation between the estimated turning amount and the actual turning amount exceeds the predetermined value, the deceleration-control is canceled. However, in this case, even if the map information is correct, there are driving conditions in which there is a deviation between the estimated turning amount and the actual turning amount, and under such conditions, there is a concern that unnecessary deceleration-control will be canceled.

In this regard, the present disclosure determines whether the deviation between the estimated turning amount and the actual turning amount is caused by factors other than the map information, and when it is determined that the deviation is caused by factors other than the map information, the deceleration-control is made less likely to be canceled than when such a determination is not made. This prevents deceleration-control from being canceled unnecessarily. As a result, it is possible to appropriately control the deceleration of the vehicle when driving around a curve.

The following describes embodiments of a vehicle control device described in the present disclosure with reference to the drawings. In the present embodiments, a driving support system is configured to provide driving support to vehicles such as passenger cars, trucks, and buses.

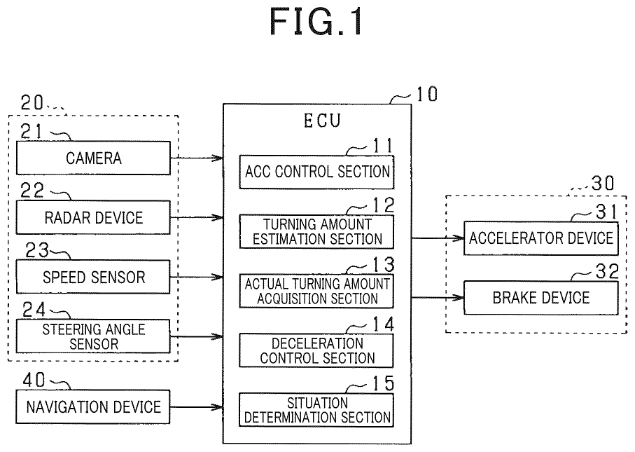

As shown in FIG. 1, a driving support system according to the present embodiment includes an ECU 10 (Electronic Control Unit) as a vehicle control device, sensors 20, controlled devices 30, and a navigation device 40. The sensors 20 include a camera 21, a radar device 22, a speed sensor 23, and a steering angle sensor 24. The controlled devices 30 include an accelerator device 31 and a brake device 32.

The camera 21 is an in-vehicle camera such as a well-known CCD camera. he camera 21 is mounted near a top of a windshield inside an own vehicle and is capable of capturing images within a predetermined range in front of the own vehicle. The camera 21 may also be mounted on the left and right sides and rear of the own vehicle. The camera 21 continuously captures images at a predetermined time interval (set cycle) and sends the captured images to the ECU 10 at the set cycle. The camera 21 may be a monocular camera or a stereo camera.

The radar device 22 is a ranging device that transmits high-frequency signals in the millimeter wave band as transmission waves. The radar device 22 is mounted, for example, at the front and rear ends of the own vehicle, and measures the distance to objects around the own vehicle. Specifically, the radar device 22 transmits probe waves at predetermined intervals and receives reflected waves via a plurality of antennas, measuring the distance to the object based on the transmission time of the probe waves and the reception time of the reflected waves. In addition, the radar device 22 calculates an azimuth of the object based on the phase difference between the reflected waves received by the plurality of antennas. By calculating the distance to the object and its azimuth, it is possible to determine the relative position of the object in relation to the own vehicle.

The speed sensor 23 is a sensor that detects the driving speed of the own vehicle. For example, a wheel speed sensor that detects the rotational speed of the wheels can be used as the speed sensor 23. The steering angle sensor 24 is a sensor that detects a steering angle of a steering wheel in the own vehicle.

The ECU 10 is an electronic control device equipped with a well-known microcomputer composed of a CPU, a ROM, a RAM, a flash memory, etc. The microcomputer provides various calculation functions. The functions provided by the microcomputer can be provided by software recorded on physical memory devices and computers that perform that software, by software alone, by hardware alone, or by a combination of the two. The microcomputer performs a program stored in a non-transitory tangible storage medium, which is a storage section therein. The program implements, for example, an object recognition process that recognizes objects around the own vehicle, and a process for avoiding collisions with objects around the own vehicle or mitigating damage in the event of a collision. When the program is performed, the method corresponding to the program is performed. The storage section is, for example, a non-volatile memory. Note that programs stored in the memory can be updated via a network such as the internet.

The ECU 10 acquires object detection information from the camera 21 and the radar device 22, respectively, and recognizes objects around the own vehicle based on the information. Specifically, the relative position and existence area of an object are calculated as image information based on the distance to the object calculated from the camera image and the direction of the object. In addition, the relative position and existence area of the object are calculated as radar information based on the distance to the object and the direction of the object contained in the distance information obtained from the radar device 22. Then, these image data and radar data are fused to recognize the object. At this point, the object is recognized based on the overlap between the object's existence area contained in the image information and the object's existence area contained in the radar information. However, in the present embodiment, the object recognition method is arbitrary, and it is possible to recognize objects based only on the object detection information from the camera 21 or only on the object detection information from the radar device 22, for example, among the object detection information from the camera 21 and the radar device 22.

The ECU 10 performs an ACC (Adaptive Cruise Control) control as the driving support control for the own vehicle. Specifically, the ECU 10 performs constant speed control of the own vehicle based on the target speed set by the driver. In addition, when there is a preceding vehicle driving ahead of the own vehicle in the direction of travel, vehicle-following control is performed to cause the own vehicle to follow the preceding vehicle while maintaining a predetermined target distance between the vehicles. In this case, the ECU 10 searches for a preceding vehicle to follow in front of the own vehicle in the direction of travel when executing the ACC control. Then, if there is no preceding vehicle, the own vehicle will maintain a constant speed at the target speed. In addition, if there is a preceding vehicle, the own vehicle will be driven at the target speed as the maximum speed while maintaining the target distance from the preceding vehicle. At this time, the ECU 10 performs speed control by adjusting the driving force and braking force of the own vehicle using the controlled device 30 in order to control the speed of the own vehicle.

In the present embodiment, the vehicle is equipped with the accelerator device 31 and the brake device 32 as the controlled devices 30. The accelerator device 31 is an engine or motor that serves as the vehicle's power source, and when the driver operates an accelerator, driving force is applied to the own vehicle itself based on control commands from the ECU 10. The brake device 32 is installed on each wheel of the vehicle, and when the driver operates brakes, braking force is applied to the own vehicle itself based on control commands from the ECU 10.

It should be noted that the ACC control can be turned on and off by the driver. For example, the ACC control is performed by the ECU 10 when the driver turns on a set switch. In addition, the ACC control by the ECU 10 is stopped when certain conditions are met, such as the driver turning off the set switch.

In addition, in the present embodiment, the ACC control is configured to perform deceleration-control that decelerates the own vehicle based on map information acquired from the navigation device 40. That is, the ECU 10 performs the deceleration-control to decelerate the own vehicle in accordance with the road conditions ahead of the vehicle based on the map information. In this case, the navigation device 40 has map information stored in the storage medium and acquires vehicle position information, which is information on the current position of the own vehicle, by means of a vehicle position sensor. Vehicle location information is information that can be received from satellite positioning systems using artificial satellites, such as a GPS (Global Positioning System) and a GNSS (Global Navigation Satellite System), and is obtained by vehicle location sensors. The map information includes information on roads that are passable by vehicles, and includes information on road conditions, such as whether the road is curved. Note that it is also desirable to include information indicating the curvature radius of the curved road as information indicating that the road is curved.

The ECU 10 acquires the vehicle position information and the map information from navigation device 40, and based on the vehicle position information and the map information, performs the deceleration-control to decelerate the own vehicle when the own vehicle is driving on a curved road. At this time, braking is performed by the brake device 32 in accordance with the curvature radius of the curved road, and the own vehicle decelerates. The curvature radius of a curved road is determined based on the map information, and the speed when driving on a curved road is determined according to the curvature radius of the curved road. Specifically, the speed when driving on a curve is lower when the curvature radius of the curve is small than when the curvature radius of the curve is large. The vehicle deceleration by the deceleration-control takes priority over speed control by the constant speed control or the vehicle-following control.

However, if the map information recognized by the own vehicle is incorrect, proper deceleration-control cannot be performed. Therefore, when driving on a curved road, it is possible to compare the turning information of the own vehicle estimated based on the map information with the turning information of the actual driving condition of the own vehicle, and cancel the deceleration-control based on the degree of deviation between the two items of turning information. In this case, the turning information of the own vehicle is the vehicle turning amount that indicates the turning state of the own vehicle, and specifically, it is the yaw rate generated by the turning of the own vehicle and the turning rate that indicates the magnitude of the turning angle of the own vehicle. On curves with a small curvature radius (i.e., curves with a large curvature), the turning amount of the own vehicle will be large, while on curves with a large curvature radius (i.e., curves with a small curvature), the turning amount of the own vehicle will be small. It should be noted that if the map information in the navigation device 40 is not updated to the latest version, the map information will be incorrect. A specific example of incorrect map information is when the curvature radius of a curved road in the map information differs from that of the actual road. In addition, although the map shows a curved road, the actual road may be straight.

However, in this case, even if the map information is correct, there is a possibility that there will be a deviation between the estimated turning information of the own vehicle based on the map information and the actual turning information of the own vehicle, and under such circumstances, there is a concern that the deceleration-control will be canceled unnecessarily. For example, when driving on a curved road, if the driver performs out-in-out driving, the curvature radius of the own vehicle's turning will be greater than the curvature of the curved road. In this case, there may be a deviation between the estimated turning information of the own vehicle based on the map information and the actual turning information of the own vehicle, and the deceleration-control may be canceled unnecessarily.

Therefore, in the present embodiment, when driving on a curved road, it is determined whether there is a situation in which a deviation between the turning information of the own vehicle estimated based on the map information and the actual turning information of the own vehicle is caused by factors other than the map information. Then, when it is determined that the deviation is caused by factors other than the map information, the deceleration-control is made less likely to be canceled than when such a determination is not made. This prevents deceleration-control from being canceled unnecessarily.

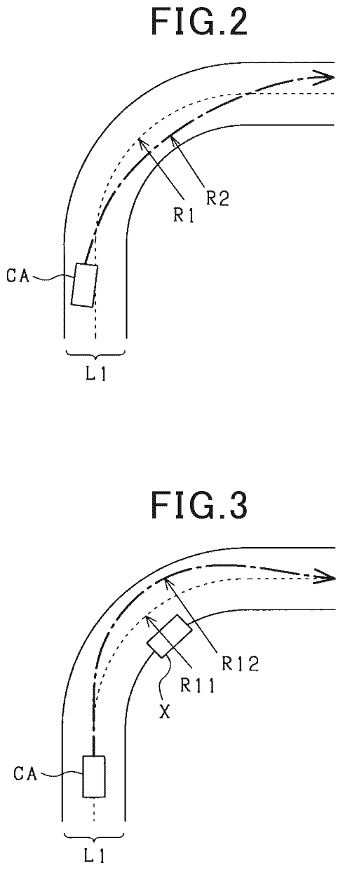

The following are examples of driving situations in which, when driving on a curved road, there is a deviation between the estimated turning information of the own vehicle based on the map information and the actual turning information of the own vehicle due to factors other than errors in the map information. Note that in FIGS. 2 to 5 below, a virtual line passing through the center position of the left and right sides of the lane L1 on a curved road is shown as a broken line, and the curvature radius of the curved road is defined by that line. In addition, the driving trajectory passing through the center position of the left and right sides of the own vehicle CA is indicated by a dotted line, and the curvature radius of the own vehicle's driving line is defined by that driving trajectory.

FIG. 2 shows a driving scene in which the own vehicle CA drives in out-in-out driving when driving on a curved road. When undergoing out-in-out driving, as indicated by the dotted line, the own vehicle CA travels along the curved road using a driving line that varies from the outer side to the inner side and then back to the outer side within its own lane L1. In this case, if the curvature radius of the curved road is R1 and the curvature radius of the driving line of the own vehicle CA is R2, then R1<R2. As a result, there is a deviation between the turning information of the own vehicle estimated based on map information and the actual turning information of the own vehicle CA. However, in this case, it is undesirable for the deceleration-control to be canceled because the deviation in the turning information is not caused by the map information.

FIG. 3 shows a driving scene in which an obstacle X exists on the inside of a curve in the driving lane L1, and the own vehicle CA drives while avoiding the obstacle X. The obstacle X refers to, for example, other vehicles stopped due to breakdowns, etc., objects that have fallen from vehicles, small animals, etc. Alternatively, the obstacle X may be another vehicle driving in the same direction as the own vehicle CA in a lane adjacent to lane L1, and driving in a position that protrudes into lane L1. The obstacle X is positioned near a boundary line on either side of the vehicle's lane or across the boundary line.

During obstacle avoidance driving, as indicated by the dotted line, the own vehicle CA drives along the curve road with a driving line that bulges toward the outside of the curve in order to avoid the obstacle X. In this case, if the curvature radius of the curved road is R11 and the curvature radius of the driving line of the own vehicle CA is R12, then R11>R12. As a result, there is a deviation between the turning information of the own vehicle estimated based on the map information and the actual turning information of the own vehicle CA. However, in this case, it is undesirable for the deceleration-control to be canceled because the deviation in the turning information is not caused by the map information.

Note that the same applies when the own vehicle CA avoids obstacle X positioned on the outside of curve L1 on the vehicle lane and continues driving. In this case, although the curvature radius R11 of the curved road and the curvature radius R12 of the driving line of the own vehicle CA differ, and there is a deviation between the turning information of the own vehicle estimated based on the map information and the actual turning information of the own vehicle CA, it is undesirable to cancel the deceleration-control.

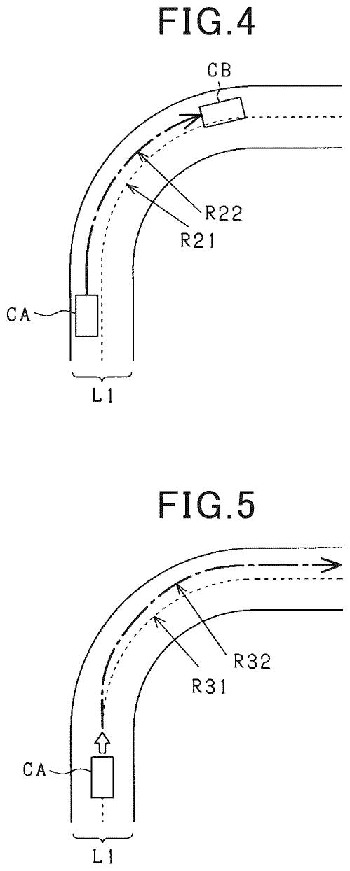

FIG. 4 shows a driving scene in which the own vehicle CA is following the preceding vehicle CB and, when driving on a curved road, the own vehicle CA is driving on the outer side of its own lane L1, as is the preceding vehicle CB. In other words, the own vehicle CA is driving along a driving line that depends on the preceding vehicle CB. In this case, if the curvature radius of the curved road is R21 and the curvature radius of the driving line of the own vehicle CA is R22, then R21<R22. As a result, there is a deviation between the turning information of the own vehicle estimated based on the map information and the actual turning information of the own vehicle CA. However, in this case, it is undesirable for the deceleration-control to be canceled because the deviation in the turning information is not caused by the map information.

Note that the same applies when the preceding vehicle CB is driving on the inner lane of its own lane L1 and the own vehicle CA is driving on the same lane as the preceding vehicle CB.

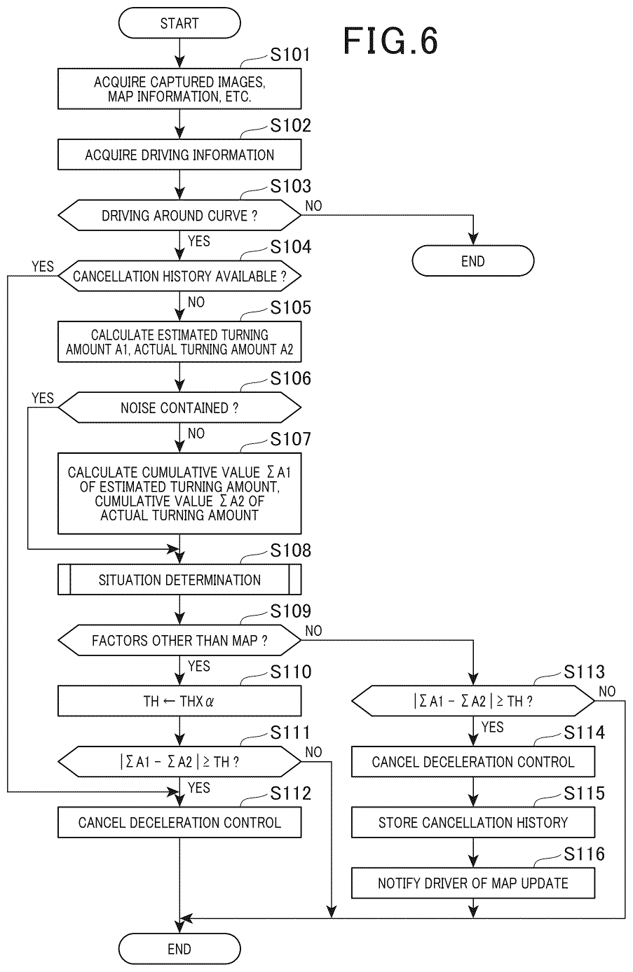

FIG. 5 shows a driving scene in which the driving speed of the own vehicle CA immediately before the curve is high, causing understeer (the driving line bulging toward the outside of the curve) of the own vehicle CA when driving on a curved road. In this case, if the curvature radius of the curved road is R31 and the curvature radius of the driving line of the own vehicle CA is R32, then R31<R32. As a result, there is a deviation between the turning information of the own vehicle estimated based on the map information and the actual turning information of the own vehicle CA. However, in this case, it is undesirable for the deceleration-control to be canceled because the deviation in the turning information is not caused by the map information.

The configuration related to the deceleration-control in the ECU 10 will be described. In FIG. 1, the ECU 10 includes an ACC control section 11, a turning amount estimation section 12, an actual turning amount acquisition section 13, a deceleration-control section 14, and a situation determination section 15. As described above, the ACC control section 11 performs the constant speed control based on the target speed, the vehicle-following control for the preceding vehicle, and the deceleration-control based on the map information.

The turning amount estimation section 12 calculates an estimated turning amount A1 based on the map information when driving on a curved road. Specifically, the turning amount estimation section 12 calculates an estimated yaw rate as the estimated turning amount A1 based on the curvature radius of the curved road included in the map information and the driving speed of the own vehicle.

The actual turning amount acquisition section 13 acquires an actual turning amount A2 indicating an actual turning state of the own vehicle when driving on a curved road. Specifically, the actual turning amount acquisition section 13 calculates an actual yaw rate as the actual turning amount A2 based on the driving speed and the steering angle of the own vehicle. Note that it is also possible to install a yaw rate sensor on the own vehicle and calculate the actual turning amount A2 (actual yaw rate) using the yaw rate sensor.

The deceleration-control section 14 cancels the deceleration-control when a degree of deviation between the estimated turning amount A1 and the actual turning amount A2 exceeds a predetermined value. Specifically, the deceleration-control section 14 calculates the difference between the estimated turning amount A1 and the actual turning amount A2, and cancels the deceleration-control when the difference exceeds a predetermined threshold value. As an indicator of the degree of deviation between the estimated turning amount A1 and the actual turning amount A2, it is also possible to calculate the difference between a cumulative value ΣA1 of the estimated turning amount A1 within a predetermined time and a cumulative value ΣA2 of the actual turning amount A2 within a predetermined time at a cumulative value calculation section. The predetermined time is, for example, a few seconds. When the degree of deviation between the estimated turning amount A1 and the actual turning amount A2 exceeds the predetermined value, it is considered that the map information is incorrect, and the deceleration-control is canceled in order to avoid incorrect deceleration-control being performed when driving on a curved road.

The situation determination section 15 determines whether the deviation between the estimated turning amount and the actual turning amount is caused by factors other than the map information. This situation determination is performed by determining at least one of the driving scenes shown in FIGS. 2 to 5, for example.

Here, it is desirable to determine whether the vehicle is undergoing out-in-out driving (refer to FIG. 2) by comparing the standard driving line defined near the center line of the road with the actual driving line of the own vehicle. Specifically, the system recognizes the boundary lines on the left and right sides of the own vehicle's lane from the images captured by the camera 21, and determines that the own vehicle is undergoing out-in-out driving if the absolute value of the difference between the own vehicle's turning amount corresponding to the center line of the lane as determined from the boundary lines and the own vehicle's actual turning amount is greater than a predetermined threshold value. Alternatively, if the absolute value of the difference between the vehicle turning amount corresponding to the driving line in the center of the lane as determined from the map information and the vehicle turning amount corresponding to the actual driving line of the own vehicle is greater than or equal to a predetermined threshold value, it is determined that the own vehicle is undergoing out-in-out driving. Note that it is possible to use the estimated turning amount A1 estimated based on the map information as the vehicle turning amount corresponding to the center line of the lane as ascertained from the map information. In addition, it is possible to use the actual turning amount A2, which is the actual turning amount of the vehicle, as the vehicle turning amount corresponding to the actual driving line of the own vehicle.

In addition, it is possible to determine whether the vehicle is undergoing out-in-out driving based on changes in the lateral distance between the own vehicle and either the left or right boundary lines. In this case, based on the lateral distance between the own vehicle and the boundary line, it is determined that the own vehicle is driving on the outer side of its lane at the entrance to the curve, and then gradually shifting toward the inner side of its lane, and based on this determination, it is determined that the own vehicle is undergoing out-in-out driving. In addition, when the ideal driving line for the own vehicle is indicated as out-in-out driving line, it may be determined that the own vehicle is undergoing out-in-out driving.

Further, it is desirable that the determination of whether the vehicle is driving while avoiding an obstacle (refer to FIG. 3) be made by determining, based on the images captured by the camera 21, that there is an obstacle inside or outside the vehicle's lane and that the own vehicle is driving along a driving line for avoiding the obstacle. Whether a driving line is for avoiding the obstacle can be determined based on the positional relationship between the own vehicle and the obstacle, as well as the positional relationship between the own vehicle and the boundary lines on either side of the lane. For example, when the own vehicle passes by the obstacle to the side, if the lateral distance to the obstacle temporarily becomes longer and the lateral distance to the boundary line on the opposite side of the obstacle becomes shorter, it is determined that the own vehicle is avoiding the obstacle.

The determination of whether the vehicle is following the preceding vehicle (refer to FIG. 4) may be made based on the image captured by the camera 21. At this time, it is advisable to also determine whether the vehicle in front is driving unevenly to one side of its lane.

When entering a curve, it is desirable to determine that the own vehicle is speeding (refer to FIG. 5) by determining that the own vehicle's driving speed is greater than a predetermined speed. In this case, it may be determined that the speed exceeds the target speed of the ACC control due to the driver's operation of an accelerator pedal.

Then, when the situation determination section 15 determines that the deviation between the estimated turning amount A1 and the actual turning amount A2 is caused by factors other than the map information, the deceleration-control section 14 makes it less likely to cancel the deceleration-control than when such a determination is not made. For example, the deceleration-control is made less likely to be canceled by increasing the threshold value for determining the difference between the estimated turning amount A1 and the actual turning amount A2. In addition, it is possible to configure the system so that deceleration-control is not canceled when it is determined that the deviation between the estimated turning amount A1 and the actual turning amount A2 is caused by factors other than the map information.

FIG. 6 is a flowchart showing the process of the deceleration-control when driving on a curved road. The present process is repeatedly performed by the ECU 10 at predetermined intervals. The present process assumes that ACC control is being performed in the own vehicle.

In FIG. 6, in step S101, the captured images from the camera 21 are acquired, and the vehicle position information and the map information are acquired from the navigation device 40. In step S102, the driving information indicating the driving status of the own vehicle is acquired. Specifically, the driving speed of the own vehicle detected by the speed sensor 23 and the steering angle of the own vehicle detected by the steering angle sensor 24 are acquired.

In step S103, it is determined whether the vehicle is driving on a curved road. The determination of whether the road is curved may be made based on the curvature radius of the boundary lines recognized from the images captured by the camera 21. Specifically, the ECU 10 recognizes boundary lines such as white lines based on brightness changes, etc. in the camera image, and calculates the curvature radius of the boundary lines. Then, if the curvature radius of the boundary line is below a predetermined threshold value, it is determined that the vehicle is driving on a curved road. When driving on the curved road, the process proceeds to the subsequent step S104.

In step S104, it is determined whether a cancellation history of the deceleration-control being canceled in the past is stored in memory for the curved road to be driven this time. Details of the cancellation history will be described later. If the cancellation history is present, the process proceeds to step S112 and cancels the deceleration-control for the curved road to be driven this time. In addition, if the cancellation history is not present, the process proceeds to step S105.

In step S105, the estimated turning amount A1 and actual turning amount A2 of the own vehicle are calculated. The estimated turning amount A1 is the vehicle turning amount estimated based on the map information, and the actual turning amount A2 is the vehicle turning amount indicating the actual driving state of the own vehicle. At this time, for example, the estimated yaw rate is calculated based on the map information as the estimated turning amount A1, and the actual yaw rate is calculated based on the driving speed and steering angle of the own vehicle as the actual turning amount A2.

Then, in step S106, it is determined whether the vehicle position information transmitted from artificial satellites contains unacceptable noise (GPS noise), i.e., whether the position information contains noise. For example, the vehicle movement amount calculated from the difference between the previous vehicle position information and the current vehicle position information at the preceding and following process timings is compared with the vehicle movement amount from the previous time to the current time calculated from the driving speed of the own vehicle. Then, if the difference between them exceeds a predetermined value, it is determined that the position information contains noise. If the decision at step S106 is negative, the process proceeds to step S107, and if the decision at step S106 is affirmative, step S107 is skipped and the process proceeds to step S108.

In step S107, the cumulative value ΣA1 of the estimated turning amount A1 within a predetermined time is calculated, and the cumulative value ΣA2 of the actual turning amount A2 within a predetermined time is calculated. It should be noted that if the position information is determined to contain noise in step S106, the turning amount accumulation value is not updated in step S107.

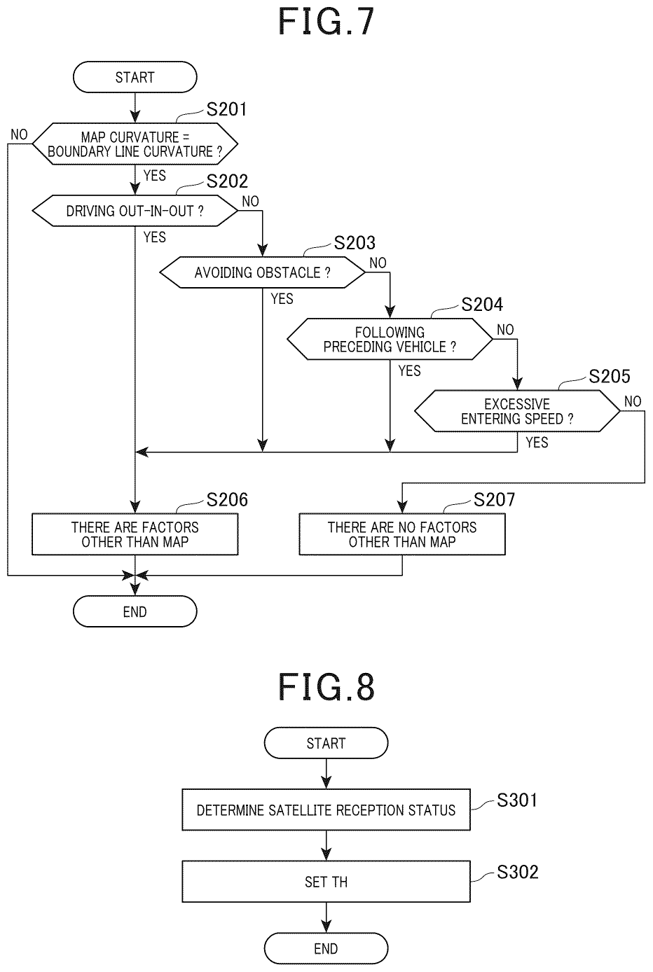

Then, in step S108, a situation determination process is performed to determine whether there is a deviation in the turning amount due to factors other than the map information during driving on the curved road. The situation determination process is explained using the flowchart in FIG. 7.

In FIG. 7, in step S201, the correctness of the map information is determined based on the difference between the curvature or curvature radius of the curved road calculated from the boundary line of the lane in which the own vehicle is driving and the curvature or curvature radius of the curved road calculated from the map information. At this point, if the absolute value of the difference in each curvature or the absolute value of the difference in each curvature radius is less than a predetermined threshold value, the map information is deemed to be correct, the decision at step S201 is affirmative, and the process proceeds to step S202. Note that the curvature or curvature radius of the curved road calculated from the boundary line corresponds to a first curvature radius, and the curvature or curvature radius of the curved road calculated from the map information corresponds to a second curvature radius.

In steps S202 to S205, it is determined whether the driving scene is one in which a deviation between the estimated turning amount A1 and the actual turning amount A2 may occur. That is, in step S202, it is determined whether the own vehicle is performing out-in-out driving. In step S203, it is determined whether there is an obstacle inside or outside the lane in which the own vehicle is driving, and whether the own vehicle is driving while avoiding the obstacle. In step S204, it is determined whether the vehicle is following the preceding vehicle when driving on the curved road. In step S205, it is determined whether the vehicle speed when entering the curved road is greater than the predetermined speed.

Then, if any of the decision in steps S202 to S205 are affirmative, the process proceeds to step S206, and if the decision in all of steps S202 to S205 are negative, the process proceeds to step S207. In step S206, it is determined that there is a situation in which the turning amount deviates due to factors other than the map information (i.e., that there are factors other than the map). In addition, in step S207, it is determined that there are no circumstances in which the turning amount deviates due to factors other than the map information (i.e., that there are no factors other than the map).

Returning to the explanation of FIG. 6, in step S109, it is determined whether the result of the determination in step S108 was that there were factors other than the map. Then, if the decision in step S109 is affirmative, the process proceeds to step S110, and if the decision in step S109 is negative, the process proceeds to step S113.

In step S110, a threshold value TH for determining the degree of deviation between the estimated turning amount A1 and the actual turning amount A2 is changed. Specifically, the threshold value TH is changed to the increase side by multiplying it by an increase correction coefficient α. The correction coefficient α is greater than 1.

In the next step S111, it is determined whether the degree of deviation between the estimated turning amount A1 and the actual turning amount A2 is greater than or equal to a predetermined value. In the present embodiment, the deviation determination of the turning amount is performed using the accumulated value ΣA1 of the estimated turning amount A1 and the accumulated value ΣA2 of the actual turning amount A2 calculated in step S107, and it is determined whether the absolute value of the difference between the accumulated values ΣA1 and ΣA2 is greater than or equal to the threshold value TH. Then, if the decision in step S111 is affirmative, the process proceeds to step S112 and cancels the deceleration-control. Furthermore, if the decision in step S111 is negative, step S112 is bypassed. This causes the deceleration-control to be performed. Here, the threshold value TH used in step S111 is the value that has been increased in step S110, and compared to when the threshold value TH that has not been increased is used, the deceleration-control is less likely to be canceled.

In addition, in step S113, as in step S111, it is determined whether the absolute value of the difference between the accumulated values ΣA1 and ΣA2 is greater than or equal to the threshold value TH. However, in step S113, the deviation determination is performed using the threshold value TH without being increased. Then, if the decision in step S113 is affirmative, the process proceeds to step S114 and cancels the deceleration-control. In addition, if the decision in step S113 is negative, the deceleration-control is performed. Furthermore, even if the decision in step S201 in FIG. 7 is negative, it is desirable that the deceleration-control be canceled in step S114.

After the deceleration-control is canceled in step S114, the cancellation history is stored in memory (a storage section) in step S115. The memory is non-volatile memory that retains stored information even after the own vehicle's power is turned off. As a result, when driving on a curved road with a stored cancellation history from this point onwards, the decision in step S104 is affirmative based on the cancellation history, and the deceleration-control is canceled.

Then, in step S116, the driver is notified that the map information is incorrect and that the map information should be updated. At this time, the driver may be notified by voice or display.

According to the embodiment described in detail above, the following excellent effects are obtained.

When implementing the deceleration-control during the curve driving of the own vehicle, it is determined whether the deviation between the estimated turning amount A1 and the actual turning amount A2 is caused by factors other than the map information. Then, when it is determined that the deviation is caused by factors other than the map information, the deceleration-control is made less likely to be canceled than when such a determination is not made. This prevents deceleration-control from being canceled unnecessarily. As a result, it is possible to properly control the deceleration of the own vehicle when driving on curves.

When undergoing out-in-out driving, the curvature radius of the own vehicle's driving line becomes larger than the actual curvature radius of the lane. In this case, even if there is a deviation between the estimated turning amount A1 and the actual turning amount A2 during out-in-out driving, the deceleration-control is less likely to be canceled, thereby preventing the deceleration-control from being canceled unnecessarily.

If there are obstacles on the inside or outside of the lane during driving on a curve, the curvature radius of the vehicle's driving line may become larger or smaller than the actual curvature radius of the lane in order to avoid the obstacles. In this case, when avoiding obstacles, even if there is a deviation between the estimated turning amount A1 and the actual turning amount A2, the deceleration-control is less likely to be canceled, thereby preventing the deceleration-control from being canceled unnecessarily.

When following a preceding vehicle, the driving line of the own vehicle may depend on the preceding vehicle, and when driving on a curved road, if the preceding vehicle drives on the outer or inner driving line of the own lane, the curvature radius of the own vehicle's driving line may become larger or smaller than the actual curvature radius of the own lane. In this case, even if there is a deviation between the estimated turning amount A1 and the actual turning amount A2 while following the preceding vehicle, the deceleration-control is less likely to be canceled, thereby preventing the deceleration-control from being canceled unnecessarily.

When entering a curved road at a speed greater than the predetermined speed, understeer may occur in the vehicle on the curved road, and the curvature radius of the own vehicle's driving line may become greater than the actual curvature radius of the lane. In this case, if the vehicle is driving at excessive speed when entering a curved road, even if there is a deviation between the estimated turning amount A1 and the actual turning amount A2, the deceleration-control is less likely to be canceled, thereby preventing the deceleration-control from being canceled unnecessarily.

When it is determined that the deviation between the estimated turning amount A1 and the actual turning amount A2 is caused by factors other than the map information, the deceleration-control is made less likely to be canceled on the condition that the difference between the first curvature radius of the curved road calculated from the recognition results of the boundary lines in the vehicle's lane and the second curvature radius of the curved road calculated from the map information is within a predetermined range. In this case, if the difference between the curvature radius of the curved road calculated from the recognition results of the boundary lines and the curvature radius of the curved road calculated from the map information is within the predetermined range, it means that the map information is correct, and based on the assumption that the map information is correct, it is possible to make it less likely to cancel the deceleration-control. This allows for proper continuation of the deceleration-control.

When the difference between the estimated cumulative turning amount within the predetermined time and the actual cumulative turning amount within the predetermined time exceeds the predetermined value, the deceleration-control is canceled. In this case, when there is a difference between the estimated turning amount A1 and the actual turning amount A2 while driving on the curved road, the difference between the two turning amounts becomes apparent by accumulating each turning amount within the predetermined time, enabling the degree of deviation to be determined appropriately. This makes it possible to improve the accuracy of canceling the deceleration-control.

When it is determined that the deviation between the estimated turning amount A1 and the actual turning amount A2 is not caused by factors other than the map information, and when the deceleration-control during cornering is canceled based on the degree of deviation between the estimated turning amount A1 and the actual turning amount A2, the cancellation history is saved, and the deceleration-control is canceled based on the cancellation history when driving on the same curved road in the future. This allows the deceleration-control to be canceled appropriately.

### Other Embodiments

The above embodiment may be modified as follows, for example.
The reliability of the vehicle location information transmitted from the artificial satellites may vary depending on the reception status of the vehicle location information from the artificial satellites. In light of this point, it is also possible to set a variable threshold value TH for determining the degree of deviation between the estimated turning amount A1 and the actual turning amount A2 based on the reception status of the vehicle location information received from the artificial satellites. Specifically, the ECU 10 may perform the process shown in FIG. 8. The present process may be performed, for example, before step S108 in FIG. 6. In step S108 and thereafter in FIG. 6, it is desirable to perform the threshold value TH correction (step S110) and the deviation determination (steps S111 and S113) using the threshold value TH set in FIG. 8.

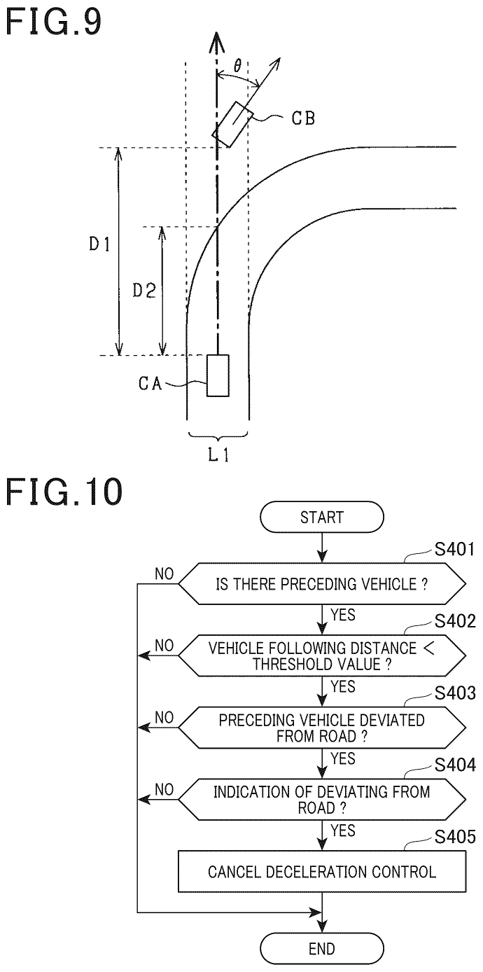

In FIG. 8, in step S301, the reception status of the vehicle position information from the artificial satellite is determined. For example, the number of artificial satellites captured (number of GPS satellites captured) is determined. Note that the positioning accuracy of the satellite positioning systems varies depending on the configuration of the satellites, and the more satellites are captured, the higher the positioning accuracy. Then, in the following step S302, the threshold value TH is variably set based on the reception status. At this time, if the number of the artificial satellites captured exceeds a predetermined number (e.g., five), the predetermined threshold value TH is reduced. This makes it easier to cancel the deceleration-control. In addition, if the number of the artificial satellites captured is less than the predetermined number, the threshold value TH is increased. This makes it more difficult to cancel the deceleration-control. According to this configuration, even if the reception status of the vehicle location information from the artificial satellites changes, it is possible to perform proper deceleration-control of the own vehicle.
When the own vehicle is following the preceding vehicle and the preceding vehicle deviates from the road recognized by the map information, the deceleration-control may be canceled. For example, as shown in FIG. 9, when driving on a curved road, if the preceding vehicle CB deviates from the road area recognized from the map information and there is a sign that the own vehicle CA will deviate from the road area while following the preceding vehicle CB, the deceleration-control is canceled. In FIG. 9, the distance between the preceding vehicle CB and the own vehicle CA is denoted as D1, the distance between the own vehicle CA and the edge of the own lane is denoted as D2, and the yaw angle of the preceding vehicle CB relative to the driving direction of the own vehicle CA is denoted as θ.

The ECU 10 may perform the process shown in FIG. 10. The present process may be performed, for example, when the decision in step S109 is negative in FIG. 6.

In FIG. 10, in step S401, it is determined whether there is a preceding vehicle to be followed in front of the own vehicle, and if there is a preceding vehicle, the process proceeds to step S402. In step S402, it is determined whether the vehicle following distance D1 between the preceding vehicle and the own vehicle is less than a predetermined threshold value, and if the vehicle following distance D1 is less than the threshold value, the process proceeds to step S403.

In step S403, it is determined whether the preceding vehicle has deviated from the road recognized by the map information. At this point, it is determined whether the vehicle following distance D1 between the preceding vehicle and the own vehicle is longer than the distance D2 between the own vehicle and the edge of the own lane. Then, if the vehicle following distance D1 between the preceding vehicle is longer than the distance D2 to the edge of the road, the decision in step S403 is affirmative and the process proceeds to step S404.

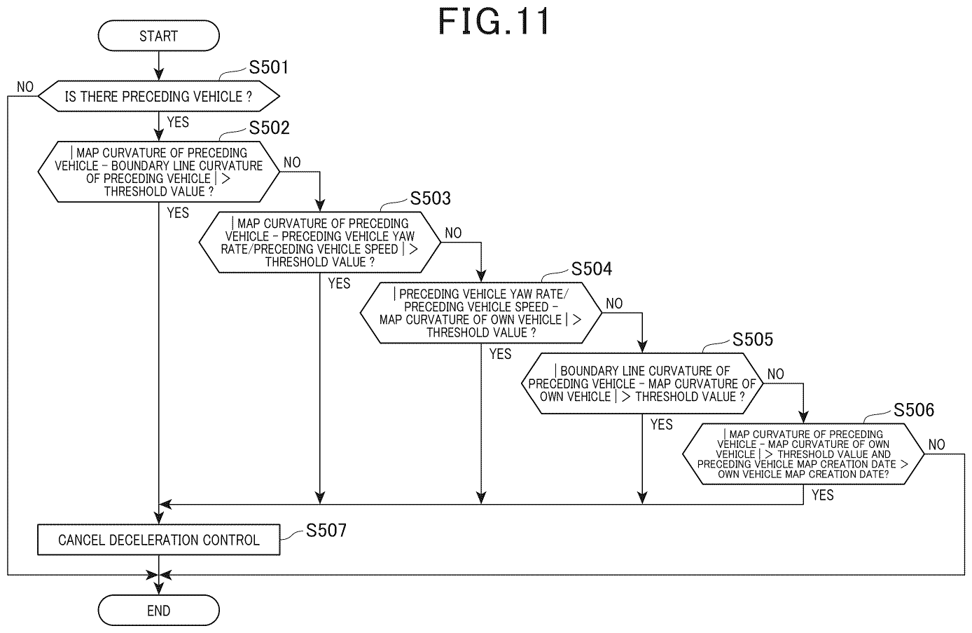

In step S404, it is determined whether there is an indication that the own vehicle will deviate from the road area while following the preceding vehicle. At this time, the yaw angle θ of the preceding vehicle is estimated from the image captured by the camera 21, and it is determined whether the yaw angle θ is within a predetermined range. Then, if the yaw angle θ of the preceding vehicle is within the predetermined range, the decision in step S404 is affirmative and the process proceeds to step S405. In step S405, the deceleration-control is canceled. This makes it possible to prevent the deceleration-control from being performed erroneously.
It is also possible to cancel the deceleration-control when the driving information is obtained from neighboring vehicles via vehicle-to-vehicle or road-to-vehicle communication, and that the driving information indicates that the map information is incorrect. Specifically, the ECU 10 may perform the process shown in FIG. 11. The present process may be performed, for example, when the decision in step S109 is negative in FIG. 6. Note that the neighboring vehicle is a vehicle driving in the same direction as the own vehicle, and in this description, a preceding vehicle driving ahead of the own vehicle is described as the neighboring vehicle.

In FIG. 11, in step S501, it is determined whether there is a preceding vehicle in front of the own vehicle and whether the driving information can be acquired from the preceding vehicle by vehicle-to-vehicle communication or road-to-vehicle communication, and if preceding information can be acquired, the process proceeds to step S502. In steps S502 to S506, a determination is made as to whether to cancel the deceleration-control based on the driving information of the preceding vehicle. Specifically:
In step S502, it is determined whether the absolute value of the difference between the map curvature of the preceding vehicle and the curvature of the boundary line captured by the preceding vehicle is greater than a predetermined threshold value.
In step S503, it is determined whether the absolute value of the difference between the map curvature of the preceding vehicle and the curvature value (preceding vehicle yaw rate/preceding vehicle speed) calculated based on the yaw rate and vehicle speed of the preceding vehicle is greater than a predetermined threshold value.
In step S504, it is determined whether the absolute value of the difference between the curvature value (yaw rate of the preceding vehicle/vehicle speed of the preceding vehicle) calculated based on the yaw rate and vehicle speed of the preceding vehicle and the map curvature of the own vehicle is greater than a predetermined threshold value.
In step S505, it is determined whether the absolute value of the difference between the curvature of the boundary line captured by the preceding vehicle and the map curvature of the own vehicle is greater than a predetermined threshold value.
In step S506, it is determined whether the absolute value of the difference between the map curvature of the preceding vehicle and the map curvature of the own vehicle is greater than a predetermined threshold value, and whether the creation date of the map information of the preceding vehicle is newer than the creation date of the map information of the own vehicle. Note that the creation date of the map information may be the update date of the map information.

Then, if any of steps S502 to S506 are affirmed, the process proceeds to step S507 and cancel the deceleration-control.
In the above embodiment, although the estimated turning amount total value and the actual turning amount total value are calculated, and when the difference between these total values exceeds the predetermined threshold value, the deceleration-control is canceled, this configuration may be modified. For example, it is possible to directly compare the estimated turning amount A1 and the actual turning amount A2, and cancel the deceleration-control when the difference between the two turning amounts exceeds a predetermined threshold value.

A control device and methods described in the present disclosure may be realized by a dedicated computer provided by configuring a processor and memory programmed to perform one or more functions embodied by the computer program. Alternatively, the control device and method described in the present disclosure may be implemented by a dedicated computer provided by configuring a processor with one or more dedicated hardware logic circuits. Alternatively, the control device and methods described in the present disclosure may be realized by one or more dedicated computers composed of a processor and memory programmed to perform one or more functions, in combination with a processor composed of one or more hardware logic circuits. In addition, the computer program may also be stored in a computer-readable, non-transitory tangible storage media as instructions to be performed by a computer.

The technical ideas extracted from the above embodiments are described below.

### [Configuration 1]

A vehicle control device that uses map information to perform deceleration-control for decelerating a vehicle when the vehicle is driving on a curved road, the vehicle control device comprising:
a turning amount estimation section that estimates, based on the map information, a vehicle turning amount indicating a turning state of the vehicle when driving on the curved road, as an estimated turning amount;
an actual turning amount acquisition section that acquires, as an actual turning amount, the vehicle turning amount that indicates an actual turning state of the vehicle when driving on the curved road;
a deceleration-control section that cancels the deceleration-control when a degree of deviation between the estimated turning amount and the actual turning amount is equal to or greater than a predetermined value; and
a situation determination section that determines whether the deviation between the estimated turning amount and the actual turning amount is caused by a factor other than the map information; wherein
when the situation determination section determines that the deviation between the estimated turning amount and the actual turning amount is caused by a factor other than the map information, the deceleration-control is made less likely to be canceled than when such a determination is not made.

### [Configuration 2]

The vehicle control device according to configuration 1, wherein
the situation determination section determines that the deviation between the estimated turning amount and the actual turning amount is caused by a factor other than the map information when the vehicle is driving in out-in-out driving.

### [Configuration 3]

The vehicle control device according to configuration 1, wherein
the situation determination section determines that the deviation between the estimated turning amount and the actual turning amount is caused by a factor other than the map information when an obstacle is present inside or outside a lane in which the vehicle is driving while the vehicle is driving and avoiding the obstacle while driving on the curved road.

### [Configuration 4]

The vehicle control device according to configuration 1, wherein
the vehicle control device further includes a function of following a preceding vehicle when the preceding vehicle is driving ahead of the vehicle, and
the situation determination section determines that the deviation between the estimated turning amount and the actual turning amount is caused by a factor other than the map information when the vehicle is following the preceding vehicle while driving on the curved road.

### [Configuration 5]

The vehicle control device according to configuration 1, wherein
the situation determination section determines that the deviation between the estimated turning amount and the actual turning amount is caused by a factor other than the map information when the driving speed of the vehicle when entering the curved road is greater than a predetermined speed.

### [Configuration 6]

The vehicle control device according to configuration 1 further includes:
a first curvature calculation section that recognizes a boundary line of a lane on which the vehicle is driving and calculates a curvature of the curved road as a first curvature from the recognized boundary line; and
a second curvature calculation section that calculates a curvature of the curved road as a second curvature from the map information; wherein
when the situation determination section determines that the deviation between the estimated turning amount and the actual turning amount is caused by a factor other than the map information, the deceleration-control section makes it less likely to cancel the deceleration-control on the condition that a difference between the first curvature and the second curvature is within a predetermined range.

### [Configuration 7]

The vehicle control device according to configuration 1 further includes:
a cumulative value calculation section that cumulates the estimated turning amount and the actual turning amount at a predetermined cycle and calculates a cumulative value of the estimated turning amount and a cumulative value of the actual turning amount within a predetermined time; wherein

### [Configuration 8]

The vehicle control device according to configuration 1, wherein
the vehicle control device acquires position information of the vehicle transmitted from an artificial satellite and performs the deceleration-control using the position information, the vehicle control device including:
a reception status determination section that determines a reception status of the position information from the artificial satellite; and
a threshold value setting section that sets a threshold value for determining the degree of deviation between the estimated turning amount and the actual turning amount based on the reception status of the position information determined by the reception status determination section when driving on the curved road.

### [Configuration 9]

The vehicle control device according to configuration 1, wherein
the vehicle control device has a function of following a preceding vehicle when the preceding vehicle is driving ahead of the vehicle, the vehicle control device including;
an off-road driving determination section that determines, when the vehicle is following the preceding vehicle, that the preceding vehicle has deviated from a road area recognized from the map information and that there is a sign that the vehicle will deviate from the road area by following the preceding vehicle; wherein
the deceleration-control section cancels the deceleration-control when the off-road driving determination section determines that there is a sign that the vehicle will deviate from the road area while driving on the curved road.

### [Configuration 10]

The vehicle control device according to configuration 1 further includes:
a storage section that stores a cancellation history when the situation determination section determines that the deviation between the estimated turning amount and the actual turning amount is not caused by a factor other than the map information and the deceleration-control section cancels the deceleration-control; wherein
the deceleration-control section cancels the deceleration-control when driving on the curved road if a cancellation history for the curved road is stored in the storage section.

What is claimed is:

1. A vehicle control device that uses map information to perform deceleration-control for decelerating a vehicle when the vehicle is driving on a curved road, the vehicle control device comprising:
a turning amount estimation section that estimates, based on the map information, a vehicle turning amount indicating a turning state of the vehicle when driving on the curved road, as an estimated turning amount;
an actual turning amount acquisition section that acquires, as an actual turning amount, the vehicle turning amount that indicates an actual turning state of the vehicle when driving on the curved road;
a deceleration-control section that cancels the deceleration-control when a degree of deviation between the estimated turning amount and the actual turning amount is equal to or greater than a predetermined value; and
a situation determination section that determines whether the deviation between the estimated turning amount and the actual turning amount is caused by a factor other than the map information; wherein
when the situation determination section determines that the deviation between the estimated turning amount and the actual turning amount is caused by a factor other than the map information, the deceleration-control is made less likely to be canceled than when such a determination is not made.

2. The vehicle control device according to claim 1, wherein
the situation determination section determines that the deviation between the estimated turning amount and the actual turning amount is caused by a factor other than the map information when the vehicle is driving in out-in-out driving.

3. The vehicle control device according to claim 1, wherein
the situation determination section determines that the deviation between the estimated turning amount and the actual turning amount is caused by a factor other than the map information when an obstacle is present inside or outside a lane in which the vehicle is driving while the vehicle is driving and avoiding the obstacle while driving on the curved road.

4. The vehicle control device according to claim 1, wherein
the vehicle control device further includes a function of following a preceding vehicle when the preceding vehicle is driving ahead of the vehicle, and
the situation determination section determines that the deviation between the estimated turning amount and the actual turning amount is caused by a factor other than the map information when the vehicle is following the preceding vehicle while driving on the curved road.

5. The vehicle control device according to claim 1, wherein
the situation determination section determines that the deviation between the estimated turning amount and the actual turning amount is caused by a factor other than the map information when the driving speed of the vehicle when entering the curved road is greater than a predetermined speed.

6. The vehicle control device according to claim 1 further includes:
a first curvature calculation section that recognizes a boundary line of a lane on which the vehicle is driving and calculates a curvature of the curved road as a first curvature from the recognized boundary line; and
a second curvature calculation section that calculates a curvature of the curved road as a second curvature from the map information; wherein
when the situation determination section determines that the deviation between the estimated turning amount and the actual turning amount is caused by a factor other than the map information, the deceleration-control section makes it less likely to cancel the deceleration-control on the condition that a difference between the first curvature and the second curvature is within a predetermined range.

7. The vehicle control device according to claim 1 further includes:
a cumulative value calculation section that cumulates the estimated turning amount and the actual turning amount at a predetermined cycle and calculates a cumulative value of the estimated turning amount and a cumulative value of the actual turning amount within a predetermined time; wherein
the deceleration-control section cancels the deceleration-control when a difference between the cumulative value of the estimated turning amount and the cumulative value of the actual turning amount is equal to or greater than a predetermined value.

8. The vehicle control device according to claim 1, wherein
the vehicle control device acquires position information of the vehicle transmitted from an artificial satellite and performs the deceleration-control using the position information, the vehicle control device including:
a reception status determination section that determines a reception status of the position information from the artificial satellite; and
a threshold value setting section that sets a threshold value for determining the degree of deviation between the estimated turning amount and the actual turning amount based on the reception status of the position information determined by the reception status determination section when driving on the curved road.

9. The vehicle control device according to claim 1, wherein
the vehicle control device has a function of following a preceding vehicle when the preceding vehicle is driving ahead of the vehicle, the vehicle control device including;
an off-road driving determination section that determines, when the vehicle is following the preceding vehicle, that the preceding vehicle has deviated from a road area recognized from the map information and that there is a sign that the vehicle will deviate from the road area by following the preceding vehicle; wherein
the deceleration-control section cancels the deceleration-control when the off-road driving determination section determines that there is a sign that the vehicle will deviate from the road area while driving on the curved road.

10. The vehicle control device according to claim 1 further includes:
a storage section that stores a cancellation history when the situation determination section determines that the deviation between the estimated turning amount and the actual turning amount is not caused by a factor other than the map information and the deceleration-control section cancels the deceleration-control; wherein
the deceleration-control section cancels the deceleration-control when driving on the curved road if a cancellation history for the curved road is stored in the storage section.

11. A vehicle control device that uses map information to perform deceleration-control for decelerating a vehicle when the vehicle is driving on a curved road, the vehicle control device comprising:
one or more processors; and
a memory storing instructions that when performed by the one or more processors causes the vehicle control device to perform:
estimating, based on the map information, a vehicle turning amount indicating a turning state of the vehicle when driving on the curved road, as an estimated turning amount;
an actual turning amount acquisition section that acquires, as an actual turning amount, the vehicle turning amount that indicates an actual turning state of the vehicle when driving on the curved road;
canceling the deceleration-control when a degree of deviation between the estimated turning amount and the actual turning amount is equal to or greater than a predetermined value; and
determining whether the deviation between the estimated turning amount and the actual turning amount is caused by a factor other than the map information; wherein
when determined that the deviation between the estimated turning amount and the actual turning amount is caused by a factor other than the map information, the deceleration-control is made less likely to be canceled than when such a determination is not made.

12. A program performed by a computer to enable deceleration-control for decelerating a vehicle when the vehicle is driving on a curved road using map information, the program comprising:
a turning amount estimation process for estimating, based on the map information, a vehicle turning amount indicating a turning state of the vehicle while driving on the curved road;
an actual turning amount acquisition process for acquiring the vehicle turning amount indicating an actual turning state of the vehicle when driving on the curved road;
a deceleration-control process for canceling the deceleration-control when a degree of deviation between the estimated turning amount and the actual turning amount is equal to or greater than a predetermined value; and
a situation determination process for determining whether the deviation between the estimated turning amount and the actual turning amount is caused by a factor other than the map information; wherein
in the deceleration-control process, when it is determined by the situation determination process that the deviation between the estimated turning amount and the actual turning amount is caused by a factor other than the map information, the deceleration-control is made less likely to be canceled than when such a determination is not made.
